(19) United States
(12) Patent Application Publication
(10) Pub. No.: US 2008/0181063 A1
(43) Pub. Date: Jul. 31, 2008

(54) OPTICAL DISC APPARATUS

(75) Inventor: Hiroshi Kubota, Machida-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/021,024

(22) Filed: Jan. 28, 2008

(30) Foreign Application Priority Data
Jan. 31, 2007 (JP) 2007-022257

(51) Int. Cl. G11B 7/09; G11B 7/085

(52) U.S. Cl. 369/44.35

(57) ABSTRACT

According to one embodiment, an optical disc apparatus provides a signal processing circuit that obtains a reflection amount of reflection light from a recording layer of a recording medium from a sum of outputs from a photo detector when moving the objective lens so as to make a distance between the recording layer of the recording medium and the lens coincide with a focal length of the lens, and limits a variation amount of numerals used as the reflection amount within a predetermined range when correcting a servo signal of the outputs from the photo detector, which is used to obtain coincidence between the distance between the recording layer of the recording medium and the lens and the focal length of the lens with a formula normalized servo error signal=servo error signal before normalization/reflection amount.

### CROSS-REFERENCE TO RELATED APPLICATIONS

This application is based upon and claims the benefit of priority from Japanese Patent Application No. 2007-022257, filed Jan. 31, 2007, the entire contents of which are incorporated herein by reference.

### BACKGROUND

1. Field

One embodiment of the present invention relates to a signal processing method that can suppress the instability in the focus control and tracking control caused by undesirable variations in focus servo gain and track servo gain while reproducing data recorded on an optical disc serving as a recording medium or recording data on an optical disc, due to a defective portion of the disc or the material of the recording layer, as well as to an optical disc to which the signal processing method can be applied.

2. Description of the Related Art

It has been a long time since an optical disc device (optical disc drive apparatus) which can reproduce recorded data by means of laser beam or record data by laser beam became commercially practical.

As recording media, optical discs of DVD (Digital Versatile Disk) standard are now very popular.

Of the optical discs of the DVD standard, types other than the ROM type optical discs for reproduction only, that is, for example, write-once optical discs in which data can be written only once and rewritable optical discs in which data can be rewritten repeatedly have such a structure that recording tracks (guiding grooves or flat surface portions which are counter-portions to the grooves) are formed on a data recording surface (of the disc).

On a recording track, the center of the spot of a laser beam used for recording data on the optical disc and that used for reproducing the data therefrom must coincide with each other. When the center of the beam spot cannot trace the center of the recording track, a tracking error occurs to make it difficult to reproduce or record data.

Here, if a finger print or some attachment which may cause an influence on the optical characteristics attaches while the user handing the disc, or when such an optical disc that uses material whose reflectivity changes abruptly when recording, which depends on the material of the recording layer, it is known that the focus servo gain and track servo gains vary undesirably, and therefore the focusing control and tracking control become unstable.

Under these circumstances, there has already been a report on a method of correcting an output from a photo-detector on the basis of the reflection amount from the recording layer in the focus servo and track servo.

For example, Japanese Patent Application Publication (KOKAI) No. 2005-50410 discloses an optical disc apparatus that performs corrections using two-step gains when normalizing a focusing error signal or tracking error signal with the “reflection amount”, in which the value of “fine (dynamic range is small (narrow), resolution is large)” ranges over, the value of “rough (dynamic range is large (wide), resolution is small)” is changed.

However, even with the method discussed in the above-mentioned document, at an instantaneous moment when the “rough (dynamic range is large (wide), resolution is small)” is changed, it is known that the following phenomena take place:

a) the value of the reflection amount temporarily drifts from a correct value; and

b) the transient response occurs due to the change of the value.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical display apparatus according to an embodiment of the invention;

FIG. 2 is an exemplary diagram showing the relationship between the servo error signal and the reflection amount from the recording layer of the optical disc on which data are recorded or from which data are reproduced by the optical disc apparatus shown in FIG. 1;

FIG. 3 is an exemplary diagram showing an example of a signal processing circuit of the optical disc device shown in FIG. 2;

FIGS. 4A and 4B are exemplary diagrams each showing the relationship between the output and reflection amount from the signal processing circuit of the optical disc apparatus shown in FIG. 3;

FIG. 5 is an exemplary diagram showing an example of a timing for combination of ON or OFF of the write gate of the optical disc apparatus shown in FIG. 1 and the “rough” or “fine” of the servo control of the PUH;

FIG. 6 is an exemplary diagram showing an example of a signal processing circuit of the optical disc apparatus shown in FIG. 1; and

FIG. 7 is an exemplary diagram showing an example of a combination (correction mode) of the “reflection amount” and the “rough” and “fine” of the servo control of the PUH in the signal processing circuit shown in FIG. 6.

### DETAILED DESCRIPTION

Various embodiments according to the invention will be described hereinafter with reference to the accompanying drawings. In general, according to one embodiment of the invention, an optical disc apparatus comprising: a lens which condenses light from a light source on a recording medium and traps reflection light from the recording medium; a support member which supports the lens so as to be movable in an optical axis direction of the lens and a tracking direction of the recording medium; a photo detector which detects the reflection light trapped by the lens and outputs a predetermined output signal; and an error signal processing unit which obtains a reflection amount of the reflection light from the recording layer of the recording medium from a sum of outputs from the photo detector when moving the support member so as to make a distance between the recording layer of the recording medium and the lens coincide with a focal length of the lens, limits a variation amount of numerals used as the reflection amount within a predetermined range when correcting a servo signal of the outputs from the photo detector, which is used to obtain coincidence between the distance between the recording layer of the recording medium and the lens and the focal length of the lens with a formula: normalized servo error signal=servo error signal before normalization/reflection amount, and maintains the numeral used as the reflection amount for a section detected to be defective.

FIG. 1 shows an example of the structure of a data recording/reproduction apparatus (optical disc apparatus” to which an embodiment of the present invention can be applied.

FIG. 1 illustrates an optical disc apparatus 1 which includes a light pickup device (optical head apparatus) 10 which can record data on a recording layer (details of which are not shown) of a recording medium (optical disc) 100, which is, for example, an organic layer, a metal layer or a phase change layer, or read data recorded on the recording layer therefrom, or erase data recorded on the recording layer. Although it will not be discussed in detail, the optical disc apparatus 1 includes, in addition to the optical head apparatus 10, elements of the mechanism, such as a head moving mechanism (not shown) which moves the optical head apparatus 10 along the recording surface of an optical disc D and a disc motor (not shown) that rotates the optical disc 100 at a predetermined speed. Further, as will be described later, the optical disc apparatus 1 includes a signal processing unit 21 that processes an output from a photo-detector built in the optical head apparatus 10, and a control unit, etc., which control the elements of the mechanism of the optical head apparatus 10.

The optical head apparatus 10 is disposed close to the optical disc 100, and it includes an objective lens 11 which collects laser light from a light source, for example, a laser diode (LD) 12 serving as a semiconductor laser element, in arbitrary recording layers L0 and L1 of the optical disc 100, and further traps the laser light reflecting from the recording layer of the optical disc 100. It should be noted here that the wavelength of the laser light output from the laser diode 12 is, for example, 400 to 410 nm, preferably, 405 nm. Further, the objective lens 11 is held on an actuator 13 and thus it is set movable in a focusing direction and tracking direction, which will be later described.

The laser light from the laser diode 12 is allowed to pass through a polarization beam splitter (PBS) 19 set at a predetermined position, and collimated (made into parallel light beams) with a collimate lens (CL) 15. Then, the collimated light is allowed to pass through a diffraction element 17 serving as a light splitter element, in which a λ/4 plate (λ/4 wavelength plate, that is, a polarization control element) is integrated to a hologram plate (hologram optical element (HOE)), and then guided to the objective lens (OL) 11. It should be noted that the objective lens 11 and the diffraction element 17 are held as an integral unit by the actuator 13.

The laser light guided to the objective lens 11 are converged to a predetermined degree by the objective lens 11 and then focused on an arbitrary one of the recording layers L0 and L1 of the optical disc 100.

It should be noted that in each of the recording layers L0 and L1 of the optical disc 100, guide grooves, that is, recording tracks, or recording (recorded data) marks (pit/pits) string are formed coaxially or spirally at a pitch of, for example, 0.34 to 1.6 μm. The numeric aperture (NA) of the objective lens 11 is, for example, 0.65.

The laser light which has been converged to a predetermined degree by the objective lens 11 is allowed to transmit through a cover layer of the optical disc (though it is not described in detail), and then focused on either one of the recording layers (or its vicinity). (Note that the laser light from the LD 12 exhibits the minimum light spot at the focal point of the objective lens 11).

The objective lens 11 is position by an objective lens drive mechanism (not shown) including, for example, a drive coil and a magnet, at a predetermined position in the tracking direction which crosses each track (recording mark (pit) string) of the optical disc 100, and at a predetermined position in the focusing direction which is the thickness direction of the recording layer. The position control of the objective lens 11 for matching the minimum light spot of the laser light with the center of a track (recording mark (pit) string) by moving the objective lens 11 in the tracking direction is called tracking control. The position control of the objective lens 11 for matching the distance between the recording layer and the objective lens 11 with the focal distance of the objective lens 11 by moving the objective lens 11 in the focusing direction is called focusing control.

The reflection laser light reflecting from an arbitrary recording layer L0 or L1 of the optical disc 100 is trapped by the objective lens 11, and then converted into substantially a parallel beam shape when a cross section thereof is viewed. After that, the light beam is returned to the diffraction element 17.

The diffraction element 17 functions also as the λ/4 plate, and therefore the reflection laser light which was returned to the diffraction element 17 and then through the diffraction element to the polarization beam splitter 19 has a polarization direction rotated by 90 degrees with respect to the polarization direction of the laser light directed to the recording layer of the optical disc 100.

The reflection laser light after reflecting on the polarization beam splitter 19 is made an astigmatic with a cylindrical lens 23 having a power inclined by 45 degrees with respect to the tangential or radial direction, and then converged at a predetermined degree by the collimate lens 15. After that, the converged light forms an image on the light receiving surface of a photo detector (PD) 14. When transmitting through the diffraction element 17, the reflection laser light is diffracted into a predetermined number of split beams and shapes in accordance with the arrangement and shape of the detection region (light receiving region) provided in advance on the light receiving surface of the photo detector 14.

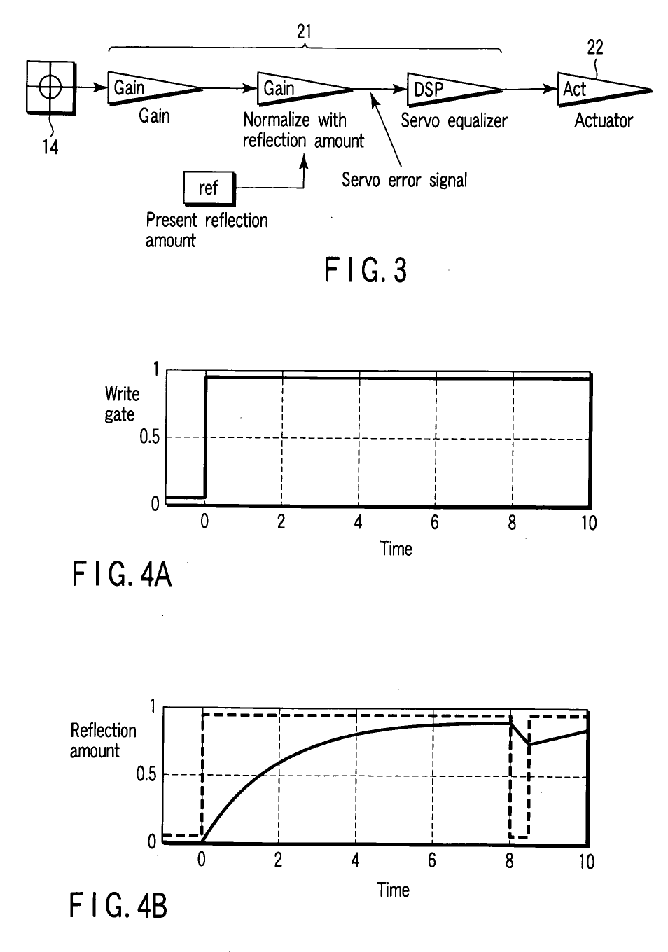

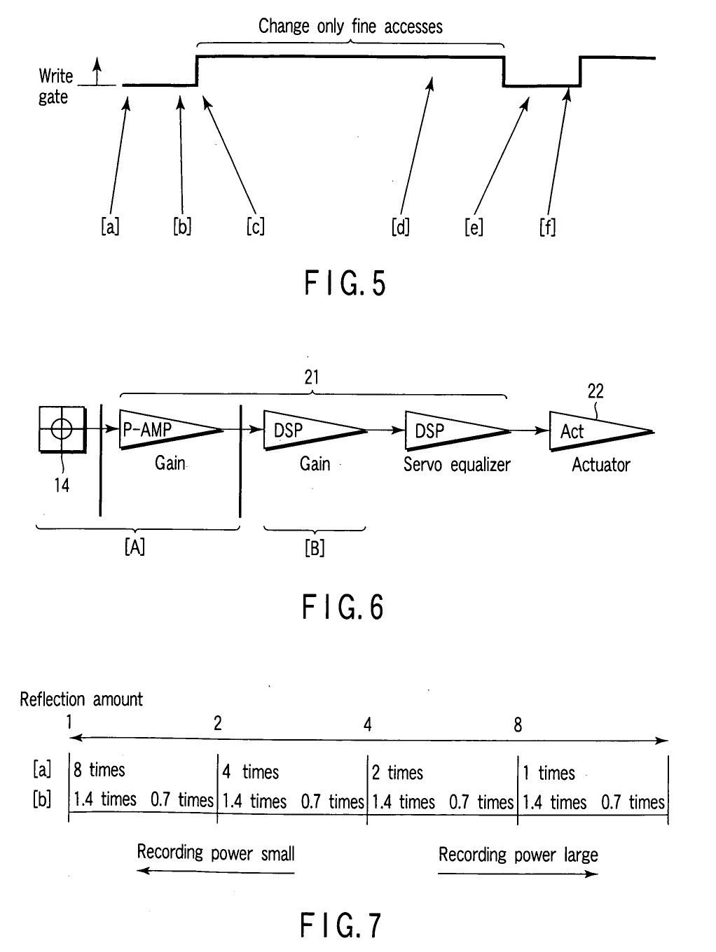

The current output from each light receiving portion of the photo detector 14 is converted into a voltage by an I/V amplifier shown in FIG. 6 (or FIG. 3), which is subjected to an arithmetical process with the signal processing unit 21 so that it can be utilized as an HF (reproduction) output, tracking error signal TE, focusing error FE, or the like. Although it will not be described in detail, the HF (reproduction) output is converted into a predetermined signal form, or it is output to, for example, a temporary memory device or an external memory device, etc. via a predetermined interface.

A signal obtained by the signal processing circuit 21 is utilized also as a servo signal for moving the position of the objective lens 11 of the optical head apparatus 10 arbitrarily in a direction normally crossing a plane including the recording surface of the optical disc 100 (which is an optical axis direction) and a direction normal to the direction in which the tracks or recording marks (pits) string formed in advance in the recording surface of the optical disc via the servo circuit 22 so as to make the distance between the objective lens 11 and an arbitrary recording layer L0 or L1 of the optical disc 100 coincide with the focal length of the objective lens 11.

It should be noted that the servo signal is generated based on the focusing error signal which indicates the change in position of the objective lens so that the light spot, which takes a predetermined size at the focus point of the objective lens 11, becomes a predetermined size on an arbitrary recording layer L0 or L1 of the optical disc 100 by the conventional focusing error detection method, and a tracking error signal which indicates the change in position of the objective lens 11 so that the light spot is guided to substantially the center of a recording mark (pit) string or track by the conventional tracking error detection method.

That is, the objective lens 11 is controlled so that a light spot converged by the objective lens 11 at substantially the center of a track or recording marks (pits/pre-pits) formed in each of the recording layers L0 and L1 of the optical disc 100 can be applied to the recording layer at its focus length so as to have its minimum spot size.

It should be noted here that when reproducing data recorded on an optical disc serving as a recording medium and recording data on an optical disc, it is known that at least one of the focus servo gain and track servo gain varies undesirably due to a deficient section which is created in optical discs in some cases, or the properties of the material of the recording layer, which makes at least one of the focusing control and tracking control unstable.

In order to avoid this, for example, when repeating “recording change to (switch) reproduction change to (switch) recording”, the value of one previous recording is used as the “reflection amount” immediately after the start of the recording is used. With use of such a method, the value of the “reflection amount” is prevented from substantially changing and thus a stable operation (servo) can be obtained even when passing on a disc failure portion (reflection amount=0) or containing noise. Note that the reflection amount is obtained as a sum of outputs from all of the optical detection regions of the photo detector 14.

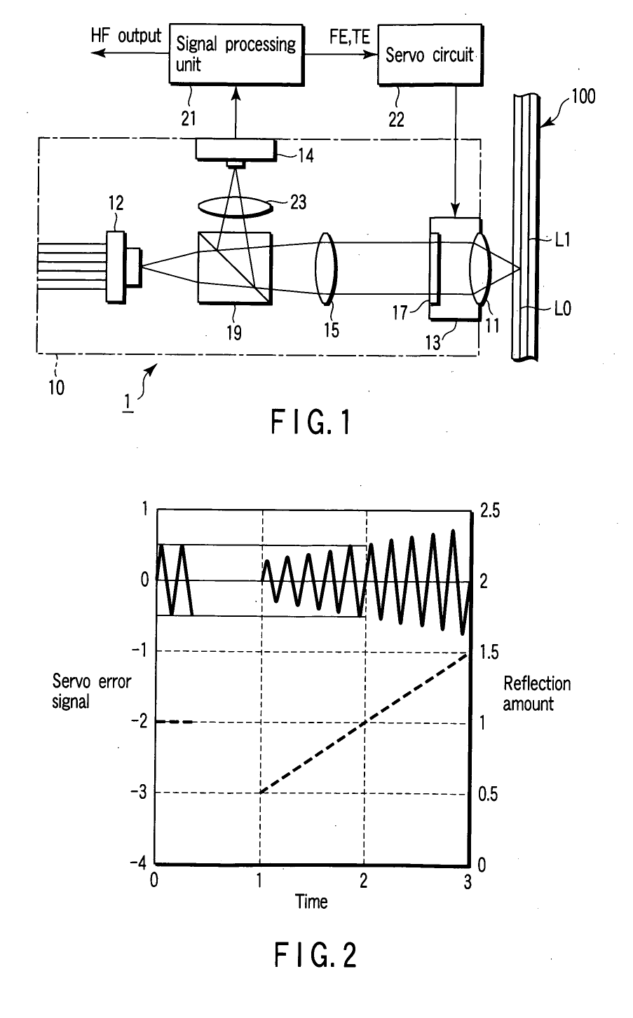

FIG. 2 shows a relationship between the output signal from the photo detector 14 built in the optical head device (PUH, pickup head) of the optical disc apparatus shown in FIG. 1 and the reflection amount from the recording layer of the optical disc.

In FIG. 2, the axis on the left-hand side indicates the servo error signal, and the axis on the right-hand side indicates the reflection amount of (the recording layer or recording surface of) the optical disc. It should be noted that as shown in the left column of FIG. 2, when the reflection amount from the optical disc is substantially flat, the amplitude of the servo error signal also falls in somewhere between a predetermined peak and bottom. However, as shown in the right column of FIG. 2, when the reflection amount from the optical disc gradually increases, the amplitude of the servo error signal gradually increases as well.

For this reason, in many PUHs, while processing an output from the photo detector (PD) 14, the output is amplified by I/V conversion up to a predetermined gain by, for example, a preamplifier (gain controller 1), and then it is further amplified by a mid amplifier (gain controller 2), as shown in FIG. 3. In this manner, an output signal in which the characteristics are compensated for by a DSP (servo equalizer or digital signal processor) is supplied from the servo circuit 22 to the actuator 13. It should be noted that in the mid amplifier (gain controller 2), the output signal from the pre-amplifier (gain controller 1) is normalized on the basis of the reflection amount of the light beam from the recording layer of the optical disc (that is, the light intensity of the light beam reflecting from the recording surface of the optical disc).

Here, the reflection amount of the optical beam during recording varies a great deal from one medium to another and depending on the temperature. Further, the allowance amount of the servo gain variation during recording is narrow. In other words, a wide dynamic range and a high normalization accuracy are required.

Due to the above-discussed background, the following measures are taken. That is, the signal processing unit 21 that processes outputs from the photo detector (PD) 14 of the PUH 10 is divided into [A] an analog processing unit (to be referred to as “rough” hereinafter) and [B] a digital processing unit (to be referred to as “fine” hereinafter) as shown in FIG. 6. Then, in the case where the write gate is turned ON or OFF in each of the timings [a] to [f] shown in FIG. 5, the modes “[A] rough” and “[B] fine” are switched over at a point during reproduction and immediately before recording as will be indicated in the timings [a] to [f] as follow:
[a] During reproduction; when acquiring value of fines when recording
[b] Immediately before recording; calculate “rough” to “fine”
[c] Change recording power; change value for “fine”
[d] Value for “fine” exceeds threshold; stop recording
[e] During reproduction; acquire value of “fines” when recording
[f] Immediately before recording;

Calculate “rough/fines” using [e] value and recording power.

It should be noted that even when the output signal from the pre-amplifier (gain controller 1) is normalized by the mid-amplifier (gain controller 2) as shown in FIG. 3, the servo gain becomes infinite (∞) in some cases as will now be described. That is, as shown in FIG. 4A, during recording (i.e. when the write rate shown in FIG. 4A is ON), when the reflection amount (the output from the PD 14) indicated by a solid line in FIG. 4B is temporarily decreased due to, for example, a defective portion of the disc or attachment of a finger print, the integral value (output used for the actual operation) indicated by dotted line in FIG. 4B varies, thereby making the servo gain infinite.

In this case, for example, the following factors for a servo error occur as described above;

a) the value of the reflection amount does not temporarily become a correct value;

b) a transient response occurs due to the change of the value.

In order to deal with this problem, the detection of defects is carried out during the normalization and when a defect is detected, the normalization is not carried out at that section, and the value immediately before that is used. It should be noted that examples of the mode of the detection of defects are the absolute value—variation rate of the reflection amount, the wobble signal amplitude, and RF (radio frequency, called normal reproduction signal) signal amplitude.

Here, examples of the values of the “recording power”, “reflection amount”, “[A] rough” and “[B] fine” are indicated in as follow:

| | | | |
|---|---|---|---|
| [a] | Recording Power | 10.0 | mW |
| | reflection amount | 2.8 | |
| | rough ([A]) | 4 | |
| | fine ([B]) | 1.0 | |
| [b] | Recording Power | 8.0 | mW |
| | reflection amount | 2.24 | |
| | rough ([A]) | 4 | |
| | fine ([B]) | 1.25 | |
| [c] | Recording Power | 7.7 | mW |
| | reflection amount | 2.15 | |
| | rough ([A]) | 4 | |
| | fine ([B]) | 1.3 | |
| [d] | Recording Power | 7.7 | mW |
| | reflection amount | 2.31 | |
| | rough ([A]) | 4 | |
| | fine ([B]) | 1.5 | |
| [e] | Recording Power | 7.7 | mW |
| | reflection amount | 2.31 | |
| | rough ([A]) | 4 | |
| | fine ([B]) | 1.5 | |
| [f] | Recording Power | 7.7 | mW |
| | reflection amount | 2.31 | |
| | rough ([A]) | 8 | |
| | fine ([B]) | 0.75 | |

More specifically, as shown in FIG. 6, the signal processing unit 21 is formed to include the analog processing unit “[A] rough” and the digital processing unit ((DSP) servo equalizer) “[B] fine” in two steps. Further, as to the reflection amount, a predetermined magnification is applied between the recording power and “[A] rough” or “[B] fine” as shown in FIG. 7. In this manner, even if the reflection amount is significantly changed from the time of recording to the time of reproduction, a stable servo can be applied.

It should be noted that when the recording power is changed (the timing [c] in FIG. 5), a servo can be applied stably even to such an optical disc that involves a significant change in recording power, which is a rewriteable disc that uses, for example, OPC as a recording layer.

Further, when the value of “[A] rough” is changed, the recording is temporarily stopped (turn off the write gate) and the value of “[B] fine” is changed. In this manner, it is possible to inhibit a transient response from occurring by switching the gain. Thus, the occurrence of the transient response at the time of changing the recording power, which has not been solved by the conventional techniques, can be substantially inhibited.

It should be pointed out that the conventional techniques for improving the response speed to the “reflection amount” may induce such new problem that they still reacts (responses) to a defect or the like, created in an optical disc, and thus in reality, increase the instability. As compared to this drawback, the present invention, since there is no need to increase the response speed undesirably, can obtain such a merit of being able to apply the servo stably.

In other words, the servo error signal at the time of recording is expressed as:

Normalized servo error signal=servo error signal before normalization/reflection.

Here, with regard to the method of generating the “reflection amount (which is always updated in recording)”, the following measures are taken. That is, for example:

the “reflection amount” is not the reflection amount as it is at that time, but the variation amount is limited; or

the “reflection amount” is not updated at a defective portion.

In this manner, even when passing through a defective portion of a disc (where the reflection amount=0) or when the disc contains noise, the value of the “reflection amount” can be controlled so as not to vary substantially, and therefore a stable operation (servo) can be achieved.

In other words, the servo error signal at the time of recording is expressed as:

Normalized servo error signal=servo error signal before normalization/reflection amount.

Here, with regard to the method of generating the “reflection amount (which is always updated in recording)”, the following measures are taken. That is, there are different values of the “reflection amount” prepared to be referred to in the recording and reproduction, and these values are separately maintained.

For example, when repeating “recording to change (switch) reproduction to change (switch) recording”, the value of one previous recording is used as the “reflection amount” immediately after the start of the recording is used. In this manner, the value of the “reflection amount” is prevented from substantially changing and thus a stable operation (servo) can be achieved even when passing on a disc failure portion (reflection amount=0) or containing noise.

Further, when the recording power is changed, the following process is carried out at the same time.

The reflection amount (after changed)=reflection amount (before changed)*function (recording power (after changed), recording power (before changed)) where the function (A, B) is a value determined with A and B. In this manner, the change in “reflection amount” along with the change in recording power is corrected in a feed forward manner. Thus, the value of the “reflection amount” is prevented from substantially changing and thus a stable operation (servo) can be achieved even when passing on a disc failure portion (reflection amount=0) or containing noise.

Furthermore, at least following two sections are set where the “reflection amount” is corrected:

[1] the “[A] rough” (when changed, the circuit offset varies, but it has a wide adjustment range) to be corrected mainly in the photo detector 14 (PDIC) and the pre-amplifier of the signal processing unit 21; and

[2] a section where the circuit offset does not vary even if the value is changed, and the resolution is high, in the “[B] fine” having to be corrected in the DSP (pre-stage of the servo equalizer) of the signal processing unit 21 (regardless of how narrow the adjustment range is).

When recording, only the “[B] fine” is changed, and when the “[B] fine” is at an end of the adjustment range, the recording is temporarily stopped, and the correction is carried out with use of the “[A] rough”. Further, before recording, an appropriate value for the “[A] rough” is calculated from the reflection amount.

It should be noted that when the value for the “[A] rough” is changed, the value for the “[B] fine” is changed as well, and thus even if there is a defective portion in the optical disc (for example, a scratch similar in shape to a track) or there is an attachment (a finger print or a viscous or solid matter to adversely affect the reflectivity), it is possible to suppress at least one of the focus servo gain and track servo gain from varying undesirably, suppressing at least one of the focusing control and tracking control from becoming unstable.

As described above, according to the present invention, while monitoring the reflection amount from the recording layer, [1] when the value for the “rough (dynamic range to large (wide), resolution to small (analog process))” is changed, the value for the “fine (dynamic range to small (narrow), resolution to large (digital process))” is changed as well, whereas [2] when the value for the “rough (dynamic range to large (wide), resolution to small)” is changed, the recording is temporarily stopped. In this manner, even if there is a defective portion in the optical disc (for example, a scratch similar in shape to a track) or there is an attachment (a finger print or a viscous or solid matter to adversely affect the reflectivity), it is possible to suppress at least one of the focus servo gain and track servo gain from varying undesirably, suppressing at least one of the focusing control and tracking control from becoming unstable.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a lens which condenses light from a light source on a recording medium and traps reflection light from the recording medium;
a support member which supports the lens so as to be movable in an optical axis direction of the lens and a tracking direction of the recording medium;
a photo detector which detects the reflection light trapped by the lens and outputs a predetermined output signal; and
an error signal processing unit which obtains a reflection amount of the reflection light from the recording layer of the recording medium from a sum of outputs from the photo detector when moving the support member so as to make a distance between the recording layer of the recording medium and the lens coincide with a focal length of the lens, limits a variation amount of numerals used as the reflection amount within a predetermined range when correcting a servo signal of the outputs from the photo detector, which is used to obtain coincidence between the distance between the recording layer of the recording medium and the lens and the focal length of the lens with a formula:
normalized servo error signal=servo error signal before normalization/reflection amount, and maintains the numeral used as the reflection amount for a section detected to be defective.

2. The optical disc apparatus according to claim 1, wherein
the error signal processing unit uses values of the reflection amount separately maintained for recording and reproduction when correcting the servo signal used to obtain coincidence between the distance between the recording layer of the recording medium and the lens and the focal length of the lens with a formula:
normalized servo error signal=servo error signal before normalization/reflection amount.

3. The optical disc apparatus according to claim 1, wherein
the error signal processing unit corrects a change in the reflection amount along with a change in recording power by carrying out a process of the reflection amount (after changed)=reflection amount (before changed)*function (recording power (after changed), recording power (before changed)) where the function (A, B) is a value determined with A and B.

4. The optical disc apparatus according to claim 3, wherein
the error signal processing unit corrects the reflection amount in a feed forward manner.

5. The optical disc apparatus according to claim 1, wherein
the error signal processing unit corrects the reflection amount by:
an analog process that corrects it mainly in the photo detector and a pre-amplifier of a later stage; and
a digital process that is carried out in a section where a circuit offset does not change if the value for the reflection amount is varied and where a resolution is high.

6. The optical disc apparatus according to claim 5, wherein
when recording, the error signal processing unit carry out the digital process only that is carried out in a section where a circuit offset does not change if the value for the reflection amount is varied and where a resolution is high.

7. The optical disc apparatus according to claim 5, wherein
the error signal processing unit carries out, when recording data, the digital process that is carried out in a section where a circuit offset does not change if the value for the reflection amount is varied and where a resolution is high; and
when reaching a final end of the adjustment range, the recording is temporarily stopped, carries out the analog process that corrects the amount mainly in the photodetector and the pre-amplifier of the later stage.

8. A signal processing method in an optical disc apparatus comprising: a lens that concentrates light from a light source on a recording medium and traps reflection light from the recording medium; a supporting member that supports the lens so as to be movable in an optical axis direction of the lens and a tracking direction of the recording medium; a photo detector that detects the reflection light trapped by the lens and outputs a predetermined output signal; and an error signal processing unit that obtains a reflection amount of the reflection light from the recording layer of the recording medium from a sum of outputs from the photo detector when moving the support member so as to make a distance between the recording layer of the recording medium and the lens coincide with a focal length of the lens, and limits a variation amount of numerals used as the reflection amount within a predetermined range when correcting a servo signal of the outputs from the photo detector, which is used to obtain coincidence between the distance between the recording layer of the recording medium and the lens and the focal length of the lens with a formula:
normalized servo error signal=servo error signal before normalization/reflection amount,
wherein
the error signal processing unit uses values of the reflection amount separately maintained for recording and reproduction.

9. A signal processing method in an optical disc apparatus comprising: a lens that concentrates light from a light source on a recording medium and traps reflection light from the recording medium; a supporting member that supports the lens so as to be movable in an optical axis direction of the lens and a tracking direction of the recording medium; a photo detector that detects the reflection light trapped by the lens and outputs a predetermined output signal; and an error signal processing unit that obtains a reflection amount of the reflection light from the recording layer of the recording medium from a sum of outputs from the photo detector when moving the support member so as to make a distance between the recording layer of the recording medium and the lens coincide with a focal length of the lens, and limits a variation amount of numerals used as the reflection amount within a predetermined range when correcting a servo signal of the outputs from the photo detector, which is used to obtain coincidence between the distance between the recording layer of the recording medium and the lens and the focal length of the lens with a formula:
normalized servo error signal=servo error signal before normalization/reflection amount, wherein
the error signal processing unit uses values of the reflection amount separately maintained for recording and reproduction, and
when recording data, the error signal processing unit sets the reflection amount after change based on the reflection amount (after changed)=reflection amount (before changed)*function (recording power (after changed), recording power (before changed)) where the function (A, B) is a value determined with A and B.
